(19) United States
(12) Patent Application Publication
(10) Pub. No.: US 2002/0010628 A1
(43) Pub. Date: Jan. 24, 2002

(54) Method of advertising and polling

(76) Inventor: Alan Burns, Oakton, VA (US)

Correspondence Address: Damon A. Neagle, SAIDMAN DesignLaw Group, 1110 Bonifant Street, Suite 510, Silver Spring, MD, 20910, US

(21) Appl. No.: 09/864,863

(22) Filed: May 24, 2001

Related U.S. Application Data
(60) Provisional application No. 60/206,596, filed on May 24, 2000.

(51) Int. Cl. G06F 17/60

(52) U.S. Cl. 705/14

(57) ABSTRACT

A method of marketing products and collecting polling information is disclosed. The method comprises putting an entire product on the Internet and rewarding users for using and/or interacting with the actual product and providing a rating for that product.

### BACKGROUND OF THE INVENTION

1. Field of The Invention

This invention relates to a method for marketing products and services and collecting consumer data via the Internet.

2. Background and Description of Related Art

The method of the present invention represents an advancement in the way in which products and services are advertised and the way in which marketing data is collected.

Traditional advertising consists of the placement of advertisements for a product or service in an advertising medium, such as television, radio, magazines, billboards and, more recently, the Internet. Such advertisements typically include information about the product or service being advertised. This type of advertising is often referred to as “stage one” advertising.

“Stage Two” advertising is a more recent development. In stage two advertising, product information is placed on the Internet and Internet users are rewarded for reading or “clicking” on the ad or information. In some cases, users are rewarded for viewing or hearing a sample of the product itself; for example, 10 to 30 seconds of a song, or a “trailer” for a movie.

At www.mypoints.com, registered users of the website are awarded points for taking surveys, making purchases at participating merchants' websites, and touring participating merchants' websites. Points may be redeemed for gift certificates, products, or services from participating merchants.

At www.firstlook.com, registered users of the website are able to listen to or view short excerpts (i.e., 30-second samples) of videos or music and submit reviews.

Radioresearch.com, Inc. provides an Internet-based polling system designed to be appended to radio station websites. The polling system allows visitors to register for “listener advisory panels” by filling out an online form which includes demographic and musical preference information, as well as the option to be added to an e-mail mailing list. Registrants who opt into the e-mail mailing list are periodically sent e-mails that request that he or she listen to 8-10 second samples of songs and submit reviews.

At the website www.ratethemusic.com, users of the site are encouraged to sign up for a “music advisory panel”. Periodically e-mails containing short samples of songs are sent to members of the music advisory panel. The e-mails request that the recipient listen to and rate each song.

### SUMMARY AND OBJECTS OF THE INVENTION

The primary object of the present invention is to provide an improved method of marketing products and collecting polling information.

The method of the present invention embodies a “third stage” of advertising which is: putting the entire product on the Internet and rewarding users for using and/or interacting with the actual product as opposed to a sample of, or information.

The method of the present invention represents a significant improvement upon both traditional (stage one) and Stage Two marketing. By using and becoming familiar with the product itself, consumers are able to make better-informed purchase decisions than when those decisions are based on only product samples or reading ads or reviews of products. In addition, the method of the present invention makes advertising more efficient for businesses, since their products are exposed to consumers who are actively seeking new products in that business' category.

### BRIEF DESCRIPTION OF THE DRAWINGS

The features and advantages of the present invention will be more fully appreciated as the same becomes better understood from the following detailed description of the preferred embodiments when considered in connection with the accompanying drawings, in which:

FIG. 1 is schematic diagram of an interface on an Internet page for a user to listen to a song and/or provide feedback concerning his or her opinion of the song; and

FIG. 2 is a flow diagram showing the process by which feedback (votes) are handled.

### DETAILED DESCRIPTION OF THE PREFERRED EMBODIMENT

The present invention comprises a website on which anyone visiting the site may listen to entire music tracks and registered users of site receive rewards for listening to music or interacting with other products and providing feedback.

In order to become a “registered user”, a person must complete a registration form, which is preferably available on the website. The registration form requests basic demographic and behavioral information about the person. Such information could include, for example:

first and last name

e-mail address

state, city and country of residence

age

gender

music buying habits

music listening preferences

Once the registration form has been completed and submitted, the person preferably receives an e-mail message at the e-mail address indicated on the registration form confirming that he or she is now a member of the website.

As stated above, a selection of songs, in digital format, is available on the website for listening by anyone visiting the website. Unlike websites of the prior art, e.g., www.ratethemusic.com, www.firstlook.com and Radioresearch.com, Inc., visitors are able to listen to each song in its entirety.

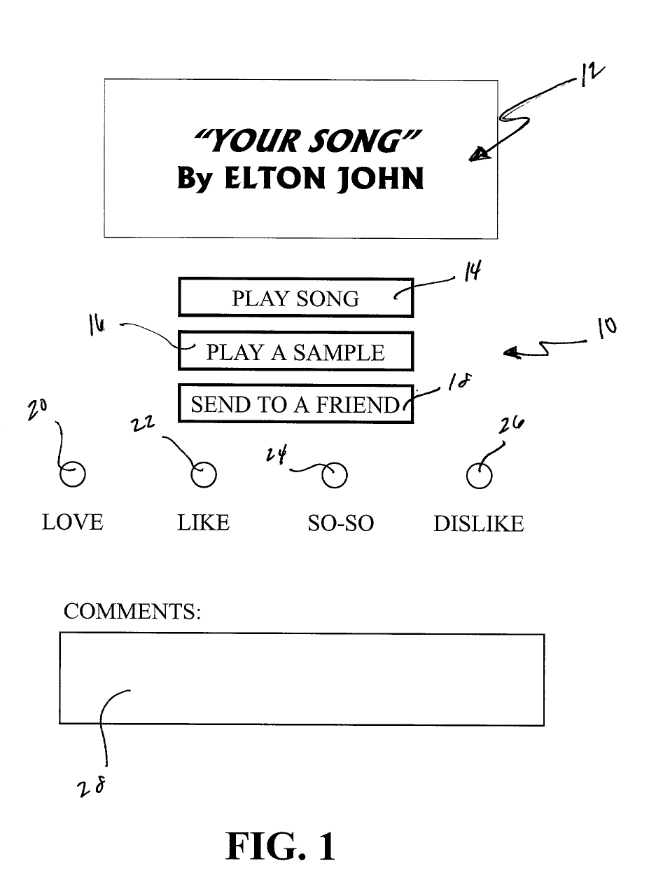

FIG. 1 shows an example of an interface 10 for use on the website. A song 12 is indicated, along with three buttons 14, 16 & 18, which allow a user to: (1) play song 12 in its entirely by clicking button 14; (2) play a sample of song 12 by clicking button 16; or (3) forward song 12 to a friend via e-mail by clicking button 18.

After listening to a particular song, a registered user may submit a review. The review may be as simple as giving the song a “rating” (i.e., love, like, so-so, or dislike), but may optionally include the opportunity to submit comments about the song. In FIG. 1, the user would have the opportunity to indicate his/her rating of the song by clicking circle 20 (“love” rating), circle 22 (“like” rating), circle 24 (“so-so” rating), or circle 26 (“dislike” rating). Comments could also be typed into box 28.

It is well-known in the music industry that people rarely form their final opinion of a song or music composition by listening to anything less than the entire song (i.e., a 10 or 30-second sample). In fact, most people must listen to a song three or more times in order to develop an accurate, final opinion about that song. Thus, registered users are encouraged to listen to a song at least three times before submitting a review. In addition, the website is preferably programmed to ignore a review of a particular song unless the registered user submitting the review has listened to the song at least once.

Registered users are offered incentives for listening to songs and submitting reviews. Such incentives could include, for example, awarding a registered user an entry into a drawing for a free gift (e.g., a compact disk or a vacation) or cash prize (e.g., $5,000) for each review submitted.

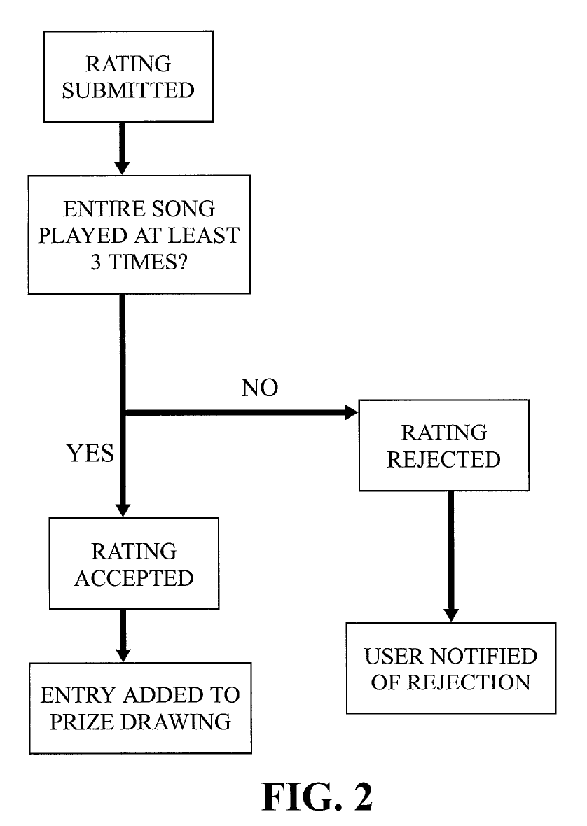

FIG. 2 is a graphical representation of the rating submission process. Reviews submitted by registered users are preferably collected in a central database and forwarded to record companies, producers, artist management and/or the artist who performed the song being reviewed.

The above-described method is an effective advertising and marketing tool. It allows businesses to deliver products directly to large numbers of consumers for their trial usage; it helps consumers make better purchase decisions; it helps businesses more efficiently reach “pre-qualified” customers; and it gathers consumer response to new products based on actual usage, rather than on “impressions” of the products formed by ads, reviews, or product samples.

The above-described method is also an inexpensive and effective polling tool. The reviews submitted by registered users for each song will provide valuable data concerning the likely commercial success of that song. In addition, the demographic and behavioral information submitted by each registered user may be used in combination with the reviews submitted by that registered user to determine the likely commercial success of each song within a particular demographic or behavioral group. Such information may be used for targeted marketing campaigns, for example.

The fact that registered users are always given the option to listen to an entire song is an important point of departure from the Internet-based marketing and polling methods of the prior art. Listening to an entire song allows the listener to form a more complete impression than only listening to a 10-30 second hook.

In addition, the method of the present invention allows registered users the freedom to listen to and review any song available on the website at his or her leisure. This stands in stark contrast to www.ratethemusic.com and Radioresearch.com's polling system where the operators of the website determine which registered users will be selected to review a particular song.

Also, the method of the present invention allows anyone (not just registered require people to register before they are allowed to listen to music available on the website. People who do not wish to divulge personal information over the Internet will likely avoid such websites.

The above-described embodiment is adapted for use in marketing and collecting market data for music. Obviously, the novel concepts disclosed are easily adaptable for use in marketing and collecting market data for a wide variety of products and services. For example, instead of (or in addition to) a song, the website could offer a chapter from a book or a story from a magazine for users to read and review, an episode from a television show for registered users to watch, or a new video or computer game to play.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention as defined in the appended claims.

Further, the purpose of the foregoing Abstract is to enable the U.S. Pat. and Trademark Office, and the public generally, and especially practitioners in the art who are not familiar with Patent or legal terms or phraseology, to determine quickly from a cursory inspection the nature and essence of the technical disclosure of the application. The Abstract is neither intended to define the invention of the application, which is measured solely by the claims, nor is intended to be limiting as to the scope of the invention in any way.

I claim as my invention:

1. A method of collecting rating data comprising the steps of:
providing means for a user to review an entire product;
providing means for said user to submit a rating of said entire product;
accepting said rating from said user if said user has reviewed said product in its entirety at least three times; and
rejecting said rating from said user if said user has not reviewed said product in its entirety at least three times.
